(19) United States
(12) Patent Application Publication
(10) Pub. No.: US 2018/0101006 A1
(43) Pub. Date: Apr. 12, 2018

(54) DISPLAY DEVICE

(71) Applicant: SHARP KABUSHIKI KAISHA, Sakai-City, Osaka (JP)

(72) Inventors: NARU USUKURA, Sakai City (JP); TAKAFUMI SHIMATANI, Sakai City (JP)

(21) Appl. No.: 15/574,228

(22) PCT Filed: May 12, 2016
(86) PCT No.: PCT/JP2016/064103

§ 371 Date: Nov. 15, 2017

(30) Foreign Application Priority Data
May 15, 2015 (JP) 2015-099717

(51) Int. Cl. G02B 27/01; G02B 27/00

(52) U.S. Cl. CPC G02B 27/0101; G02B 27/0025; B60K 35/00; B60K 2350/2065; B60K 2350/2052

(57) ABSTRACT

A display device is provided in which distortion of a displayed image is suppressed easily. A display device 1 includes a light source 2, a mirror 3, a screen 5, and an optical element 6. A normal line N1 of the optical element 6 at a position where a main light beam X3 is incident is positioned on a side to a light beam F4 at a one-side end of an intermediate image, with respect to the main light beam X3. A normal line N2 of a reflection surface of the mirror 3 is positioned on a side to a light beam F1 at other-side end of the intermediate image, with respect to a main light beam X2 outgoing from the mirror 3. A light outgoing surface P3 of the screen is tilted with respect to a plane P4 vertical to the main light beam X3, in such a direction that an optical path of the light beam F4 at the one-side end of the intermediate image, between the screen 5 and the optical element 6, is shortened.

### TECHNICAL FIELD

The present invention relates to a display device.

### BACKGROUND ART

In recent years, a head-up display or a head-mounted display, as one embodiment of a display device, has been developed, in which a surface of a transparent planar body is caused to reflect light that composes an image, so that the image is made visible in a state of being superimposed on the background.

For example, Patent Document 1 discloses a head-up display that includes a laser beam source, a screen, and a combiner. In this configuration, the screen forms an intermediate image of an image to be displayed, by enlarging the exit pupil of the light emitted from the laser beam source. The combiner reflects light from the screen, thereby causing an image corresponding to the incoming beam to be displayed as a virtual image. The surface of the screen is arranged so as to intersect at right angles with the direction in which the virtual image is viewed, so as to suppress the distortion of the virtual image.

### PRIOR ART DOCUMENT

### Patent Document

Patent Document 1: the publication of Japanese Patent No. 5214060

### SUMMARY OF THE INVENTION

### Problem to be Solved by the Invention

With the prior art described above, however, the distortion of the displayed image cannot be suppressed sufficiently in some cases, depending on the configuration of the display device. The present application, then, discloses a display device in which the distortion of the displayed image is easily suppressed.

### Means to Solve the Problem

A display device according to one embodiment of the present invention includes a light source; a mirror that reflects light from the light source; a screen on which an intermediate image is formed with the light reflected by the mirror; and an optical element that reflects light of the intermediate image on the screen, or allows the light of the intermediate image to pass therethrough, thereby generating a display image. A normal line of an incidence surface of the optical element on which a main light beam from the screen to the optical element is incident is positioned on a side of a light beam at a one-side end of the intermediate image, with respect to the main light beam incident on the optical element. A normal line of a reflection surface of the mirror when displaying a center of the intermediate image is positioned on a side of a light beam at the other-side end of the intermediate image, with respect to a main light beam traveling from the mirror toward the screen. A light outgoing surface of the screen is tilted, with respect to a plane vertical to the main light beam traveling from the screen to the optical element, in such a direction that an optical path of the light beam at the one-side end of the intermediate image, between the screen and the optical element, is shortened.

### Effect of the invention

According to the disclosure of the present application, the distortion of the displayed image is easily suppressed in the display device.

### BRIEF DESCRIPTION OF DRAWINGS

FIG. 1 illustrates a configuration of a display device in Embodiment 1.

FIG. 2 illustrates an exemplary intermediate image projected on a screen 5 in FIG. 1.

FIG. 3 illustrates an exemplary display image displayed on a combiner 6 in FIG. 1.

FIG. 4 is a diagram for explaining details of an exemplary configuration of the display device 1 illustrated in FIG. 1.

FIG. 5 is a graph illustrating the relationship among a tilt angle β, MTF, and distortion.

FIG. 6 is a diagram for explaining a value indicative of distortion.

FIG. 7 illustrates an intermediate image on the screen 5, and a graph indicating the brightness distribution thereof.

FIG. 8 illustrates an image in a display image obtained by causing the combiner to reflect the intermediate image illustrated in FIG. 7, and a graph indicating the brightness distribution thereof.

FIG. 9 illustrates an exemplary configuration of a display device in Embodiment 2.

FIG. 10 illustrates an exemplary configuration of a display device in Embodiment 3.

FIG. 11 illustrates an exemplary configuration of a display device in Embodiment 4.

FIG. 12 illustrates an exemplary configuration of a display device in Embodiment 5.

### MODE FOR CARRYING OUT THE INVENTION

A display device according to one embodiment of the present invention includes a light source; a mirror that reflects light from the light source; a screen on which an intermediate image is formed with the light reflected by the mirror; and an optical element that reflects light of the intermediate image on the screen, or allows the light of the intermediate image to pass therethrough, thereby generating a display image. A normal line of an incidence surface of the optical element on which a main light beam from the screen to the optical element is incident is positioned on a side of a light beam at a one-side end of the intermediate image, with respect to the main light beam incident on the optical element. A normal line of a reflection surface of the mirror when displaying a center of the intermediate image is positioned on a side of a light beam at the other-side end of the intermediate image, with respect to a main light beam traveling from the mirror toward the screen. A light outgoing surface of the screen is tilted, with respect to a plane vertical to the main light beam traveling from the screen to the optical element, in such a direction that an optical path of the light beam at the one-side end of the intermediate image, between the screen and the optical element, is shortened (the first configuration).

According to the above-described first configuration, the tilt of the incidence direction of the main light beam traveling from the screen to the optical element, with respect to the normal line, and the tilt of the outgoing direction of the main light beam traveling from the mirror to the screen, with respect to the normal line, are opposite to each other, with reference to the intermediate image. Besides, a light outgoing surface of the screen is tilted in such a direction that an optical path of a light beam at the one-side end of the intermediate image, between the screen and the optical element, is shortened. This causes the distortion of the image caused by the tilt of the light outgoing from the mirror, and the distortion of the image caused by the tilt of light incident on the optical element, to be opposite to each other, whereby the distortion as a whole is suppressed. Further, in the above-described arrangement of the mirror and the optical element, the outgoing surface of the screen is tilted in the above-described manner, whereby the distortion of the image can be further suppressed. By setting the relative positions of the mirror, the screen and the optical element in this way, the distortion of the image can be suppressed effectively. This consequently makes it easy to suppress the distortion of the image in the display device.

The configuration can be such that an incidence angle of the main light beam with respect to the optical element, and an incidence angle of the light from the light source with respect to the mirror when displaying the center of the intermediate image, are approximately equal to each other (the second configuration).

In the second configuration, the distortion of the image caused by the tilt of light outgoing from the mirror, and the distortion of the image caused by the tilt of the light incident on the optical element, have opposite directions, and approximately equal degrees of distortion. These distortions efficiently cancel each other, whereby the distortion of the image as a whole can be suppressed further. The case where the above-described incidence angles are equal to each other encompasses a case where the incidence angles of the both are strictly equal to each other, and in addition to this, a case where these are different to such an extent that influences of the difference on the image quality and the like are ignorable.

The configuration can be such that, when the incidence angle of the main light beam from the screen to the optical element is given as α, an angle between the light outgoing surface of the screen and the plane vertical to the main light beam traveling from the screen toward the optical element is set to α to 1.5 α (the third configuration). This makes it possible to suppress the distortion of the image more effectively.

The configuration can be such that the normal line of the incidence surface of the optical element on which the main light beam is incident, and the normal line of the mirror when displaying the center of the intermediate image, are approximately parallel (the fourth configuration). Here, the normal line of the mirror can be the normal line of the reflection surface of the mirror at a position where the main light beam is reflected. The fourth configuration makes it possible to suppress the distortion of the image more effectively. The above-described case where the normal lines are parallel encompasses a case where the normal lines can be regarded as being optically parallel. Besides, the above-described case encompasses a case where the normal lines are strictly parallel, and in addition to this, a case where the directions of the normal lines are different to such an extent that influences of the difference on the image quality and the like is ignorable.

The configuration may be such that the optical element has a reflection surface that reflects the light of the intermediate image from the screen thereby causing light of the display image to outgo. In this case, an angle between a direction of the main light beam incident on the optical element from the screen, and a direction of the main light beam outgoing from the optical element thereby forming the display image, is approximately equal to an angle between a direction of light from the light source incident on the mirror when displaying the center of the intermediate image, and a direction of an outgoing light beam that outgoes from the mirror when displaying the center of the intermediate image and travels toward the screen (the fifth configuration).

With the fifth configuration, an optical element that reflects light of the intermediate image from the screen, thereby generating the display image. This configuration is such that the distortion of the image caused by the tilt of the incidence direction of the main light beam traveling from the screen to the optical element, and the distortion of the image caused by the tilt of the incidence direction of the light traveling from the light source to the mirror, cancel each other.

The configuration can be such that the optical element allows light from a surface on a side opposite to the screen to pass therethrough, thereby superimposing background on the display image (the sixth configuration). With this configuration, the optical element allows the background and the display image to be viewed in a superimposed state.

The display device can further include an optical member that reflects light from the optical element, thereby changing the direction of light of the display image, and at the same time, allows light from a surface on a side opposite to the optical element to pass therethrough, thereby superimposing background on the display image (the seventh configuration). This makes it possible to allow the display image to be displayed in a state of being superimposed on the background of the optical member.

The display device can further include an optical compensation element provided, either between the mirror and the screen, or between the screen and the optical element, the optical compensation element performing optical compensation (the eighth configuration).

### Embodiment

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of part of constituent members is omitted. Further, the dimension ratios of the constituent members illustrated in the drawings do not necessarily indicate the real dimension ratios.

In the following description of the embodiments, an example in which a display device is applied to a head-up display is described. The display device of the present invention, however, is not limited to a head-up display.

### Embodiment 1

### (Exemplary Configuration of Display Device 1)

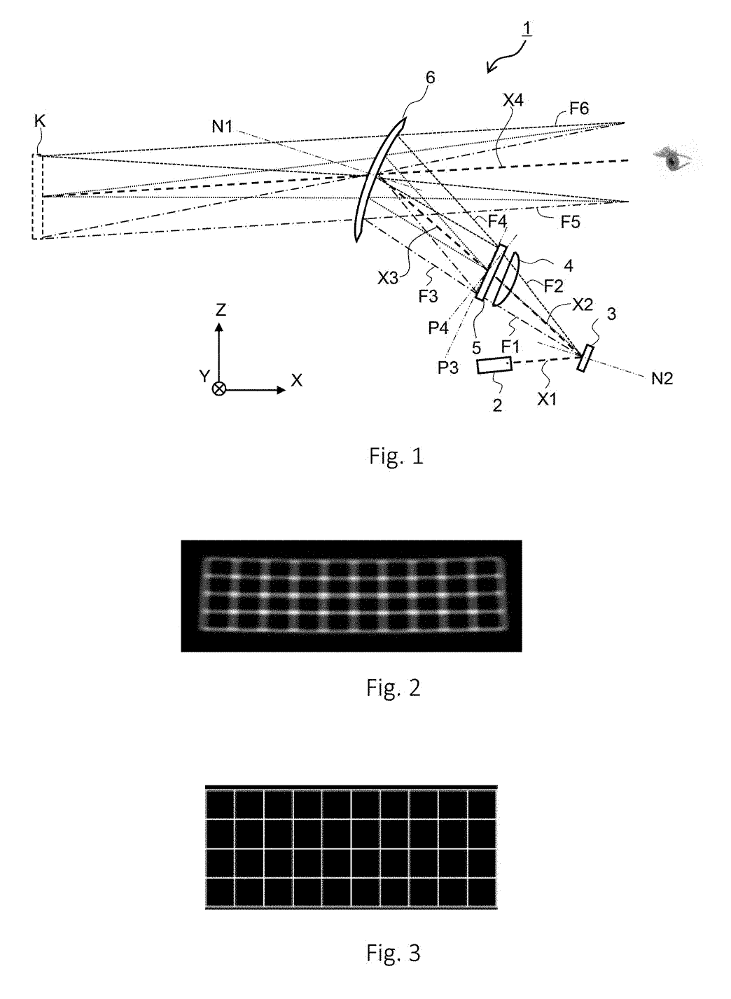

FIG. 1 illustrates an exemplary configuration of a display device 1 in Embodiment 1. FIG. 1 illustrates a cross-sectional configuration of the same on a plane that contains a line extended between the center of the image displayed by the display device 1 and the assumed viewpoint position. In FIG. 1, the horizontal plane is assumed to be the XY plane in the XYZ coordinate system, and the vertical direction is assumed to be the Z axis. FIG. 1 illustrates the cross-sectional view along the XZ plane.

The display device 1 includes a light source 2, a mirror 3, a field lens 4, a screen 5, and a combiner 6. The mirror 3 reflects light from the light source 2. The light reflected by the mirror 3 passes through the field lens 4, arid reaches the screen 5. At the screen 5, an intermediate image is formed with the light from the mirror 3. Light of the intermediate image is projected from the screen 5 to the combiner 6. In this way, the screen 5 has an incidence surface on which the light from the mirror 3 is incident, and an outgoing surface from which the light of the intermediate image outgoes. The combiner 6 reflects light of the intermediate image from the screen 5, thereby generating a display image. In other words, the light outgoing from the combiner 6 that has received light from the screen 5 forms a display image. The display image formed with the light reflected by the combiner 6 is viewed as a virtual image K by a user.

The mirror 3 reflects light from the light source, and projects the same onto the screen 5. The light source 2 projects light of colors corresponding to an image to be displayed, to the mirror 3. The direction of the reflection surface of the mirror 3 is changeable. The direction of the reflection surface of the mirror 3 is controlled, in accordance with the timing of light projection from the light source 2. With this, the position on the screen 5 at which light is projected, and the timing of projecting the light on the screen 5, are controlled. In other words, by the operations of the light source 2 and the mirror 3, the intermediate image is projected on the screen 5.

For example, by moving the reflection surface of the mirror 3, a target area on the screen 5 can be scanned by light of the light source 2. More specifically, the intermediate image can be drawn on the screen 5 by raster scanning. As the mirror 3, a microelectromechanical systems mirror (MEMS mirror) can be used. As the light source 2, a laser beam source that emits laser beams of three principal colors of red, green, and blue can be used. The light source 2 and the mirror 3 can compose a laser projector that functions as a video engine.

The configurations of the mirror 3 and the light source 2 are not limited to the configurations of the above-described example. For example, the mirror 3 may include a plurality of MEMS mirrors that correspond to the pixels, respectively. In this case, the turning ON/OFF of light of each pixel can be controlled by respective angles of the MEMS mirrors. More specifically, LED light sources of three principal colors (red, green, and blue) may be used in the light source 2, so as to compose a video image engine of the digital light processing (DLP) type in which digital micromirror devices (DMD) are used in the mirror 3.

The screen 5 is a transmission-type screen on which an intermediate image is formed with light from the mirror 3, the image thus formed being projected toward the combiner 6. The screen 5 is a two-dimensional light source. As the screen 5, for example, a light distribution screen formed by laminating a microlens array and a lenticular lens can be used. Or alternatively, the screen 5 may have a configuration that includes a scattering plate.

Between the screen 5 and the mirror 3, a field lens 4 is inserted. The field lens 4 has a spherical convex surface on which light from the mirror 3 is incident. The outgoing surface of the field lens 4 on a side opposite to the incidence surface thereof is a flat surface. The field lens 4 allows light from the mirror 3 to be efficiently projected to the screen 5. The field lens 4 may be arranged between the screen 5 and the combiner 6, or may be omitted.

The combiner 6 is an exemplary optical element that reflects light of an intermediate image on the screen 5 or allows the same to pass therethrough, thereby generating a display image. In the example illustrated in FIG. 1, the combiner 6 is a half mirror that reflects light of the intermediate image from the screen 5, thereby to display the same as a display image obtained by enlarging the intermediate image (virtual image K). The incidence surface of the combiner 6 on which the light from the screen 5 incident (this surface can be referred to as a reflection surface) is formed in a spherical concave shape. By adjusting the curvature of the reflection surface of the combiner 6, the size of the virtual image K or the position at which the virtual image is formed can be varied.

Besides, the combiner 6 superimposes the background on the display image by allowing light from the surface thereof opposite to the screen 5 side to pass therethrough. This causes it to appear to a user as if there is a virtual image K ahead of the combiner 6. In this way, the combiner 6 also functions as a concave mirror that allows the light of the background to pass therethrough, and at the same time, reflects the light from the screen 5. The combiner 6, therefore, can have such a configuration that the reflection surface thereof is coated with, for example, a beam splitter coating. Further, the configuration of the combiner 6 may be, not such a configuration that the half mirror is used, but such a configuration that, for example, cholesteric liquid crystal or a hologram element is used.

### (Exemplary Arrangement of Mirror, Screen, and Combiner)

A light beam passing through the center, among light beams traveling from the screen 5 toward the combiner (optical element) 6 to form an intermediate image, is a main light beam X3. In other words, the main light beam X3 is a light beam that passes through the midpoint between a light beam F4 at one-side end of the intermediate image and a light beam F3 at the other-side end of the intermediate image, which is the end on the side opposite to the one-side end, in an area between the screen 5 and the combiner (optical element) 6 through which light for displaying an intermediate image passes. In this way, the main light beam X3 passes between the light beam F4, which displays the one-side end of the intermediate image, and the light beam F3, which displays the other-side end of the intermediate image. The other-side end of the intermediate image is an end of the intermediate image on a side opposite to the one-side end.

The main light beam X3 displays the center of the intermediate image and the center of the display image. The main light beam X3 can be considered a line extending between the center of the intermediate image on the screen 5 and the center of the display image on the combiner (optical element) 6.

Similarly, the light beam passing through the center, among light beams of the intermediate image traveling from the mirror 3 toward the screen 5, is a main light beam X2. The main light beam X2 displays the center of the intermediate image. The main light beam X2 passes through the midpoint between a light beam F2 that displays a one-side end of the intermediate image, and a light beam F1 that displays the other-side end of the intermediate image.

Similarly, the light beam passing through the center, among light beams of the display image traveling from the combiner 6 to the user's viewpoint position, is a main light beam X4. The main light beam X4 displays the center of the display image. The main light beam X4 passes through the midpoint between a light beam F6 that displays a one-side end of the display image, and a light beam F5 that displays the other-side end of the display image.

In the example illustrated in FIG. 1, the one-side end is the upper end of the image, and the other-side end is the lower end of the image. In other words, when viewed form the user side, the upper end of the display image is the one-side end, and the lower end of the display image is the other-side end. The one-side end and the other-side end, however, are not limited to those in this example. For example, the right end and the left end of the intermediate image can be assumed to be the one-side end and the other-side end.

In this way, in the present embodiment, the main light beams X3 and X4 are the light beams that pass through the center of light that forms the display image and the center of light that forms the intermediate image, respectively, among the light beams emitted from the light source 2 in the optical system of the display device 1. In other words, the main light beams X3 and X4 can be the light beams displaying the center of the display image and the center of the intermediate image, respectively. In the example illustrated in FIG. 1, the light beam passing through the midpoint between the light beam F2 at the one-side end of the intermediate image and the light beam F1 at the other-side end of the same, among the light beams that form the intermediate image, which travel from the mirror 3 to the screen 5, is the main light beam X2. Further, the light beam passing through the midpoint between the light beam F4 at the one-side end of the intermediate image and the light beam F3 at the other-side end of the intermediate image, among the light beams of the intermediate image traveling from the screen 5 toward the combiner 6, is the main light beam X3. Still further, the light beam passing through the midpoint between the light beam F6 at the one-side end of the display image and the light beam F5 at the other-side end of the display image, among the light beams of the display image, outgoing from the combiner 6, is the main light beam X4.

On the incidence surface of the combiner 6, the main light beam X3 from the screen 5 is incident. The normal line N1 of the incidence surface of the combiner 6, at a position at which the main light beam X3 is incident, is positioned on a side of the light beam F4 at the one-side end of the intermediate image, with respect to the main light beam X3, which is incident on the combiner 6. In other words, in the plane containing the normal line N1 and the main light beam X3, the normal line N1 is positioned on the side of the light beam F4, which is at the one-side end of the intermediate image, with respect to the main light beam X3. In the present example, the normal line N1 of the incidence surface of the combiner 6 on which the main light beam X3 is incident is positioned between the light beam F4, which displays the one-side end of the intermediate image, and the main light beam X3.

The main light beam X2, which passes through the center, among the light beams of the intermediate image traveling from the mirror 3 toward the screen 5, displays the center of the intermediate image on the screen 5. The main light beam X2 is reflected on the reflection surface of the mirror 3 when displaying the center of the intermediate image. The normal line N2 of the reflection surface of the mirror 3, at a position at which the main light beam X2 is reflected, is positioned on the side of the light beam F1 at the other-side end of the intermediate image with respect to the main light beam X2 traveling from the mirror 3 toward the screen 5. In other words, in a plane containing the normal line N2 and the main light beam X2, the normal line N2 is positioned on a side of the light beam F1 at the other-side end of the intermediate image, with respect to the main light beam X2.

The light outgoing surface P3 of the screen 5 is tilted, with respect to a plane P4 that is vertical to the main light beam X3 traveling from the screen 5 toward the combiner 6. The light outgoing surface P3 of the screen 5 is tilted in such a direction that the optical path of the light beam F4 at the one-side end of the intermediate image, from the screen 5 to the combiner 6, is shortened. In the example in FIG. 1, the light outgoing surface P3 of the screen 5 is tilted in such a manner that the end of the screen 5 on the side of the light beam F4 at the one-side end of the intermediate image is closer to the combiner 6, as compared with the end thereof on the opposite side. In other words, the light outgoing surface P3 is tilted in such a manner that, in the plane containing the main light beam X3 and the normal line N1, the optical path of the light beam F4 at the one-side end of the intermediate image, between the screen 5 and the combiner 6, is shortened, whereas the optical path of the light beam F3 at the other-side end of the intermediate image, between the screen 5 and the combiner 6, is elongated.

The relative positional relationship among the mirror 3, the screen 5, and the combiner 6 is set as illustrated in FIG. 1, whereby the distortion of the displayed image can be suppressed easily. In the above-described configuration, respective distortions of the image in the mirror 3, the screen 5, and the combiner 6, due to the tilt of the light incidence direction (the outgoing direction) are canceled by one another. In the display image viewed by a user as a virtual image, therefore, the distortion is suppressed. This makes it possible to reduce, for example, the load of correcting the image by image processing.

FIG. 2 illustrates an exemplary intermediate image projected on the screen 5 in the display device 1 illustrated in FIG. 1. FIG. 3 illustrates an exemplary display image that is displayed on the combiner 6 in the display device 1, and is viewed by a user. In the example illustrated in FIG. 2, the intermediate image formed on the screen 5 has a trapezoid shape having a wide lower base and a narrow upper base. In the above-described configuration, the light source 2 is arranged below (on the other side to) the intermediate image, at a position lower than the mirror 3. In other words, a light beam X1 is incident onto the mirror 3, from below the intermediate image. As illustrated in FIG. 2, therefore, the lower part of the intermediate image is wider than the upper part of the same.

In a case where the intermediate image as illustrated in FIG. 2 is projected onto the combiner 6, the intermediate image is deformed, depending on the relative relationship between the reflection surface of the combiner 6 and the outgoing surface of the screen 5. Consequently, as illustrated in FIG. 3, a display image having a rectangular shape, with the distortion being eliminated, is displayed on the combiner 6. In the above-described configuration, the surface of the combiner 6 on which the main light beam X3 is incident is arranged in such a manner that the normal line N1 is positioned on the side of the upper end (on the one-side end side) of the intermediate image with respect to the main light beam X3. Besides, the screen 5 is tilted in such a direction that the optical path of the light beam F4 at the upper end side (the one-side end side) of the intermediate image, between the combiner 6 and the screen 5, is shortened. This allows the display screen (FIG. 3) in which the distortion of the intermediate image is eliminated to be displayed on the combiner 6.

The inventors of the present application carried out the backward ray tracing by projecting light from the user's viewpoint position toward the combiner 6 so as to cause the concave surface of the combiner 6 to reflect the light. Consequently, they found an arrangement of the combiner 6, the screen 5, and the mirror 3 for reproducing light that appropriately reaches the user's viewpoint from the virtual image K. As an example, in FIG. 1, in a configuration in which the screen 5 is arranged below (on the other side to) the display image, at a position lower than the combiner 6, the screen 5 is tiled in such a direction that the upper side part (the one-side end part) of the intermediate image becomes closer to the combiner 6. When the backward ray tracing is carried out in this configuration, the light reflected by the combiner 6 is appropriately collected onto the screen 5. This makes it possible to display, to a user, a virtual image that has high visibility and high resolution.

### (Details of Exemplary Arrangement of Mirror, Screen and Combiner)

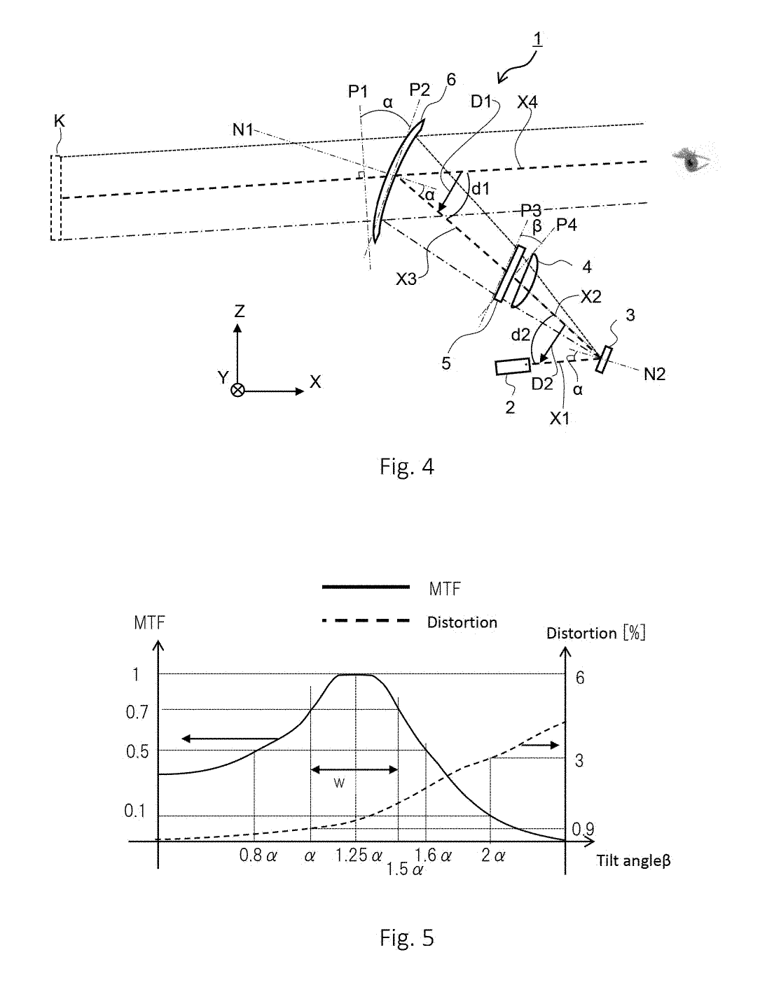

FIG. 4 is a diagram for explaining details of the exemplary arrangement of the mirror 3, the screen 5, and the combiner 6 in the display device 1 illustrated in FIG. 1

In the example illustrated in FIG. 4, the combiner 6 has a reflection surface that reflects light of an intermediate image from the screen 5, whereby a display image outgoes therefrom. When viewed in a direction (the Y direction) vertical to the plane containing the normal line N1 and the main light beam X3, the main light beam X3 from the screen 5, incident on the combiner 6, is positioned at a lower position (at a position shifted in a first direction D1), as compared with the main light beam X4 outgoing from the combiner 6. Further, the beam X1 from the light source 2 to the mirror 3 when displaying the center of the intermediate image is positioned at a lower position (that is, at a position shifted in a second direction D2 that is identical to the first direction D1), as compared with the beam X2 traveling from the mirror 3 toward the screen 5. In this way, the relative positional relationship of the incoming beam with respect to the outgoing beam regarding the combiner 6, and the relative positional relationship of the incoming beam with respect to the outgoing beam regarding the mirror 3 are set to be identical to each other, whereby the distortion of the image can be suppressed efficiently. Here, the direction D1 and the direction D2 do not have to be in an identical plane.

In this example, an incidence angle α of the main light beam X3 with respect to the combiner 6, and an incidence angle α of the beam X1 from the light source 2 that is incident on the with respect to the mirror 3 when displaying the center of the intermediate image, are approximately equal to each other. Besides, the angle d1 between the main light beam X3 incident on the combiner 6 and the main light beam X4 outgoing from the combiner 6 is approximately equal to the angle d2 between the beam X1 from the light source 2 that is incident on the mirror 3 when displaying the center of the intermediate image, and the main light beam X2 traveling from the mirror 3 toward the screen 5 (d1=d2). By arranging the mirror 3 and the combiner 6 in this way, the distortion of the image caused by the mirror 3 and the distortion of the image caused by the combiner 6 can be canceled by each other. This makes it easier to suppress the distortion of the image.

Further, the normal line N1 of the incidence surface of the combiner 6, at a position at which the main light beam X3 is incident, and the normal line N2 of the reflection surface of the mirror 3 when displaying the center of the intermediate image, are approximately parallel with each other. In other words, a contact plane P2 with respect to the combiner 6 at a position thereon at which the main light beam X3 is incident, and the reflection surface of the mirror 3 when displaying the center of the intermediate image, are approximately parallel with each other. This makes it further easier to suppress the distortion of the image.

As illustrated in FIG. 4, if the incidence angle of the main light beam X3 from the screen 5 with respect to the combiner 6 is given as α, then, the angle formed between the plane P1 vertical to the line extending between the assumed position of the user's viewpoint and the position on the combiner 6 at which the main light beam X3 is reflected (the center of the display image), and the contact plane P2 with respect to the combiner 6 at a position at which the main light beam X3 incident, is a as well. Here, an angle β between the light outgoing surface P3 of the screen 5 and the plane P4 that is vertical to the main light beam X3 traveling from the screen 5 toward the combiner 6 can be set to, for example, 0.8α to 1.6α, and further preferably, α to 1.5α. This makes it possible to efficiently suppress the distortion of the image, and further, to enhance the display quality. By the way, α can be set to, for example, 20°≤α≤40°, as a practical range.

FIG. 5 is a graph illustrating the relationship between the tilt angle β, the modulation transfer function (MTF), and the distortion. FIG. 5 illustrates the results of analysis obtained by simulation.

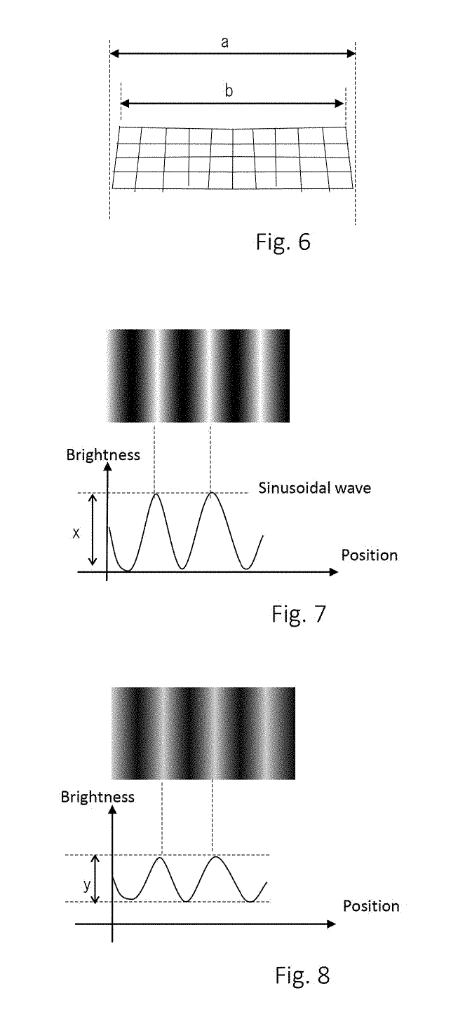

The values of distortion shown in FIG. 5 are calculated by (1−b/a)×100 (%), by using the maximum value a and the minimum value b of the length in the horizontal direction in the shape of a rectangular image in a case where the rectangular image is distorted as illustrated in FIG. 6. MTF is a value used as an index indicating the value of blur. MTF is a value indicating what change occurs in a virtual image K (display image) in a case where, for example, an image having a certain space frequency is displayed on the screen 5.

FIG. 7 illustrates an intermediate image having brightness distribution in a sinusoidal wave pattern in one direction in the screen 5, and a graph indicating the brightness distribution. The difference between the maximum value and the minimum value of the brightness of the intermediate image on the screen 5, that is, the amplitude of the sinusoidal wave, is given as “x”. FIG. 8 illustrates an image in a virtual image K (display image) obtained by causing the combiner 6 to reflect the intermediate image illustrated in FIG. 7, and a graph thereof. The amplitude of the sinusoidal wave of the display image is given as “y”, and then, MTF can be expressed as, for example, y/x.

According to the simulation results indicated in FIG. 5, in a case where the tilt angle β of the screen satisfies 0.8α≤β≤1.6α, MTF is equal to, or greater than, 0.5. Further, when the tilt angle β satisfies β≤2α, the distortion value is equal to, or less than, 3%. Still further, in a case where the tilt angle β satisfies α≤β≤1.5α, MTF is equal to, or less than, 0.7. Still further, the tilt (the rate of change) of the distortion value changes, at the tilt angle β=α. In other words, the degree of change of the distortion value with respect to the change of β is greater when β>α, as compared with when β<α. Based on this, it can be considered that even if β is set to be smaller than α, this makes less contribution to the elimination of the distortion. For this reason, by setting the tilt angle β so as to satisfy α≤β≤1.5α (the range of W in FIG. 5), a display image having less distortion and blur and having a high display quality can be provided.

### Embodiments 2

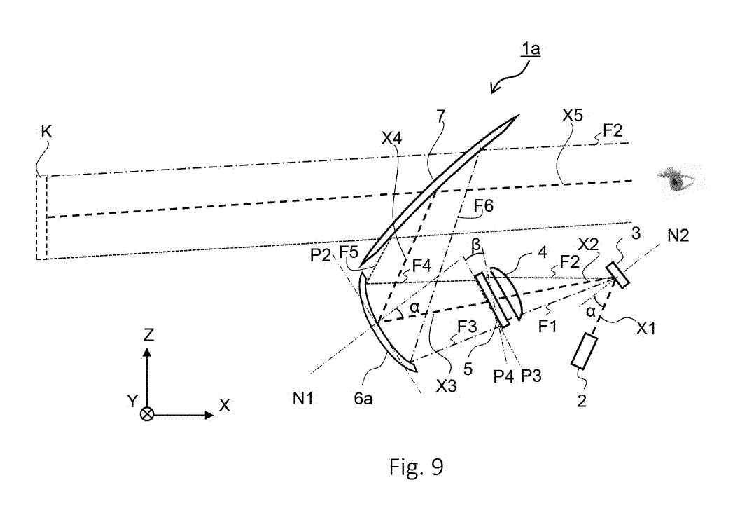

FIG. 9 illustrates an exemplary configuration of a display device 1a in Embodiment 2. The display device 1a illustrated in FIG. 9 has the configuration of the display device 1 illustrated in FIG. 1 in which a concave mirror 6a is provided in place of the combiner 6. The display device 1a further includes a combiner 7 that is provided separately from the concave mirror 6a.

The concave mirror 6a is an exemplary optical element that reflects light of the intermediate image of the screen 5 or allows the same to pass therethrough, thereby generating a display image. In the example illustrated in FIG. 9, the concave mirror 6a reflects light of the intermediate image from the screen 5, thereby generating a display image obtained by adjusting the size of the intermediate image. In other words, the reflection light of the concave mirror 6a is projected as a display image to the combiner 7. The surface of the concave mirror 6a on which the light from the screen 5 is incident (this surface can be referred to as a “reflection surface”) is a spherical concave surface. By adjusting the curvature of the reflection surface of the concave mirror 6a, the size of the virtual image K and the position at which the virtual image is formed can be varied. It should be noted that the concave mirror 6a does not have to allow the light from the surface thereof on the side opposite to the reflection surface thereof for reflecting the light from the screen 5 to pass therethrough.

The light projected from the concave mirror 6a to the combiner 7 is reflected by the combiner 7. The light reflected by the combiner 7 is viewed by a user as a display image (a virtual image). The combiner 7 also allows light from the surface thereof on the side opposite to the surface on which the light from the concave mirror 6a is incident (this surface can be referred to as the “reflection surface”), to pass through the combiner 7 itself. This makes it possible to allow the display image (the virtual image K) formed with the light reflected on the reflection surface to be shown to a user in a state of being superimposed on the background of the combiner 7. In this way, the combiner 7 is an example of an optical member that reflects light from the concave mirror 6a to change the direction of light of a display image, and at the same time, allows light from the surface thereof on the side opposite to the concave mirror 6a side to pass therethrough, so as to superimpose the background on the display image.

The combiner 7 is also a concave mirror that reflects light from the concave mirror 6a. The combiner 7, therefore, can have, for example, such a configuration that the reflection surface thereof is covered with a beam splitter coating. The combiner 7 also can have, other than the half mirror configuration, for example, such a configuration that cholesteric liquid crystal, a hologram element, or the like is used.

For example, in a case where the display device 1a is used in a head-up display of a vehicle, the windshield of the vehicle can be used as the combiner 7. With this configuration, it appears to the driver of the vehicle as if the display of the virtual image K exists ahead of the windshield. From the display, the driver can get a variety of drive assistance information.

In the display device 1a illustrated in FIG. 9, the main light beam X3 passing through the center, among the light beams of the intermediate image traveling from screen 5 to the concave mirror 6a, displays the center of the display image on the concave mirror 6a. The main light beam X3 passes between the light beam F4 displaying the one-side end of the intermediate image, and the light beam F3 displaying the other-side end of the intermediate image.

The main light beam X3 from the screen 5 is incident on the reflection surface of the concave mirror 6a. The normal line N1 of the reflection surface of the concave mirror 6a, at a position at which the main light beam X3 is incident, is positioned on a side of the light beam F4 at the one-side end of the intermediate image, with respect to the main light beam X3, which is incident on the concave mirror 6a. In other words, in the plane containing the normal line N1 and the main light beam X3, the normal line N1 is positioned on the side of the light beam F4, which is at the one-side end of the intermediate image, with respect to the main light beam X3. In the present example, the normal line N1 of the surface of the concave mirror 6a on which the main light beam X3 is incident is positioned between the light beam F4, which displays the one-side end of the intermediate image, and the main light beam X3.

The main light beam X2, which passes through the center, among the light beams of the intermediate image traveling from the mirror 3 toward the screen 5, displays the center of the intermediate image on the screen 5. The main light beam X2 is reflected on the reflection surface of the mirror 3 when displaying the center of the intermediate image. The normal line N2 of the reflection surface of the mirror 3, at a position of reflection of the main light beam X2, is positioned on the side of the light beam F1 at the other-side end of the intermediate image with respect to the main light beam X2 traveling from the mirror 3 toward the screen 5.

The light outgoing surface P3 of the screen 5 is tilted, with respect to a plane P4 that is vertical to the main light beam X3 traveling from the screen 5 toward the concave mirror 6a. The light outgoing surface P3 of the screen 5 is tilted in such a direction that the optical path of the light beam F4 at the one-side end of the intermediate image, from the screen 5 to the concave mirror 6a, is shortened. In this example, the light outgoing surface P3 of the screen 5 is tilted in such a manner that the end of the screen 5 on the side of the light beam F4 at the one-side end of the intermediate image is closer to the concave mirror 6a, as compared with the end thereof on the opposite side. In other words, the light outgoing surface P3 is tilted in such a manner that, in the plane containing the main light beam X3 and the normal line N1, the optical path of the light beam F4 at the one-side end of the intermediate image, between the screen 5 and the concave mirror 6a, is shortened, whereas the optical path of the light beam F3 at the other-side end of the intermediate image, between the screen 5 and the concave mirror 6a, is elongated.

The relative positional relationship among the mirror 3, the screen 5, and the concave mirror 6a is set as illustrated in FIG. 9, whereby the distortion of the displayed image can be suppressed easily.

In the configuration illustrated in FIG. 9 as well, as is the case with Embodiment 1, the concave mirror 6a and the mirror 3 can be arranged in such a manner that an incidence angle α of the main light beam X3 with respect to the concave mirror 6a, and an incidence angle α of the beam X1 from the light source 2 with respect to the mirror 3 when displaying the center of the intermediate image, are approximately equal to each other. Besides, the angle between the incidence direction of the main light beam X3 with respect to the concave mirror 6a and the outgoing direction of the main light beam X4 outgoing from the concave mirror 6a can be set approximately equal to the angle between the incidence direction of the beam X1 from the light source 2 with respect to the mirror 3 when displaying the center of the intermediate image, and the direction of the outgoing beam traveling from the mirror 3 toward the screen 5. This makes it possible to efficiently cancel the distortion of the image.

Further, the concave mirror 6a and the mirror 3 can be arranged so that the normal line N1 of the incidence surface of the concave mirror 6a, at a position at which the main light beam X3 is incident, and the normal line N2 of the reflection surface of the mirror 3 when displaying the center of the intermediate image, are approximately parallel with each other. In other words, a contact plane P2 with respect to the concave mirror 6a at a position at which the main light beam X3 is incident, and the reflection surface of the mirror 3 when displaying the center of the intermediate image, are approximately parallel with each other. This makes it further easier to suppress the distortion of the image.

Here, as is the case with Embodiment 1, the incidence angle of the main light beam X3 from the screen 5 to the concave mirror 6a in FIG. 9 is given as α. In this case, an angle β between the light outgoing surface P3 of the screen 5 and the plane P4 that is vertical to the main light beam X3 traveling from the screen 5 toward the concave mirror 6a can be set to, for example, 0.8α to 1.6α, and further preferably, α to 1.5α. This makes it possible to efficiently suppress the distortion of the image, and further, to enhance the display quality.

### Embodiment 3

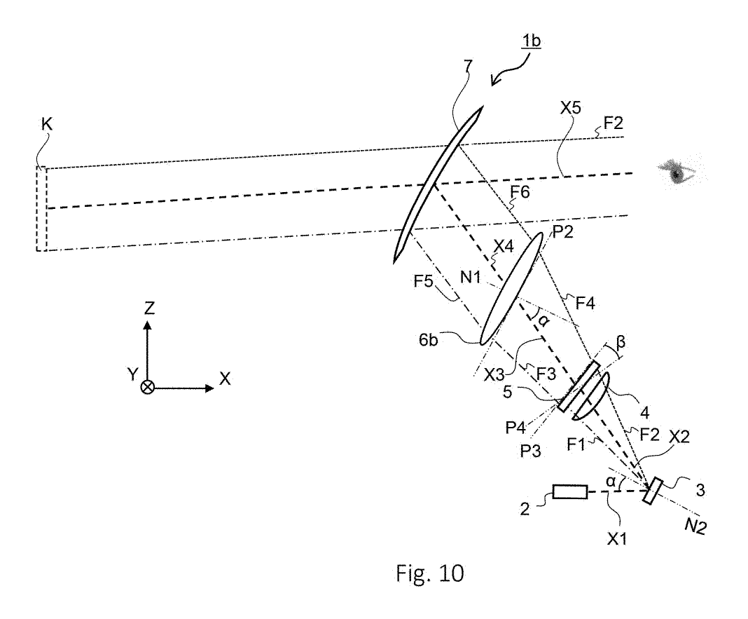

Embodiment 3 is a modification example of Embodiment 2. In the present embodiment, a lens is used as an optical element, in place of the concave mirror 6a. FIG. 10 illustrates an exemplary configuration of a display device 1b in Embodiment 3. The display device 1b in FIG. 10 is the display device 1a in FIG. 9 including a lens 6b, in place of the concave mirror 6a. The lens 6b is an exemplary optical element that allows the light of the intermediate image of the screen 5 to pass therethrough, thereby generating a display image. The lens 6b allows the light of the intermediate image from the screen 5 to pass therethrough, thereby generating a display image obtained by adjusting the size of the intermediate image. The outgoing beam from the lens 6b is projected as a display image to the combiner 7.

The lens 6b is, as one example, a convex lens. The size of the virtual image K, and the position at which the virtual image is formed, can be varied, depending on the properties of the lens 6b.

In the display device 1b illustrated in FIG. 10, the main light beam X3 passing through the center, among the light beams of the intermediate image traveling from screen 5 to the lens 6b, passes between the light beam F4 displaying the one-side end of the intermediate image, and the light beam F3 displaying the other-side end of the intermediate image.

The main light beam X3 from the screen 5 is incident on the incidence surface of the lens 6b. The normal line N1 of the incidence surface of the lens 6b, at a position at which the main light beam X3 is incident, is positioned on a side of the light beam F4 at the one-side end of the intermediate image, with respect to the main light beam X3, which is incident on the lens 6b. In other words, in the plane containing the normal line N1 and the main light beam X3, the normal line N1 is positioned on the side of the light beam F4, which is at the one-side end of the intermediate image, with respect to the main light beam X3.

The main light beam X2 is reflected on the reflection surface of the mirror 3 when displaying the center of the intermediate image. The normal line N2 of the reflection surface of the mirror 3, at a position thereon at which the main light beam X2 is reflected, is positioned on the side of the light beam F1 at the other-side end of the intermediate image with respect to the main light beam X2 traveling from the mirror 3 toward the screen 5.

The light outgoing surface P3 of the screen 5 is tilted, with respect to a plane P4 that is vertical to the main light beam X3 traveling from the screen 5 toward the lens 6b. The light outgoing surface P3 of the screen 5 is tilted in such a direction that the optical path of the light beam F4 at the one-side end of the intermediate image, from the screen 5 to the combiner 6, is shortened. In this example, the light outgoing surface P3 of the screen 5 is tilted in such a manner that the end of the screen 5 on the side of the light beam F4 at the one-side end of the intermediate image is closer to the lens 6b, as compared with the end thereof on the opposite side. In other words, the light outgoing surface P3 is tilted in such a manner that, in the plane containing the main light beam X3 and the normal line N1, the optical path of the light beam F4 at the one-side end of the intermediate image, between the screen 5 and the lens 6b, is shortened, whereas the optical path of the light beam F3 at the other-side end of the intermediate image, between the screen 5 and the lens 6b, is elongated.

The relative positional relationship among the mirror 3, the screen 5, and the lens 6b is set as illustrated in FIG. 10, whereby the distortion of the displayed image can be suppressed easily.

In the configuration illustrated in FIG. 10 as well, as is the case with Embodiment 1, the lens 6b and the mirror 3 can be arranged in such a manner that an incidence angle α of the main light beam X3 with respect to the lens 6b, and an incidence angle α of the beam X1 from the light source 2 with respect to the mirror 3 when displaying the center of the intermediate image, are approximately equal to each other. This makes it possible to cause the distortion of the image caused by the mirror 3, and the distortion of the image caused by the lens 6b, to be canceled efficiently with each other.

Further, the lens 6b and the mirror 3 can be arranged so that the normal line N1 of the incidence surface of the lens 6b, at a position at which the main light beam X3 is incident, and the normal line N2 of the reflection surface of the mirror 3 when displaying the center of the intermediate image, are approximately parallel with each other. In other words, a contact plane P2 with respect to the lens 6b at a position at which the main light beam X3 is incident, and the reflection surface of the mirror 3 when displaying the center of the intermediate image, are approximately parallel with each other. This makes it further easier to suppress the distortion of the image.

Here, as is the case with Embodiment 1, the incidence angle of the main light beam X3 from the screen 5 to the lens 6b in FIG. 10 is given as α. In this case, an angle β between the light outgoing surface P3 of the screen 5 and the plane P4 that is vertical to the main light beam X3 traveling from the screen 5 toward the lens 6b can be set to, for example, 0.8α to 1.6α, and further preferably, α to 1.5α. This makes it possible to efficiently suppress the distortion of the image, and further, to enhance the display quality.

### Embodiment 4

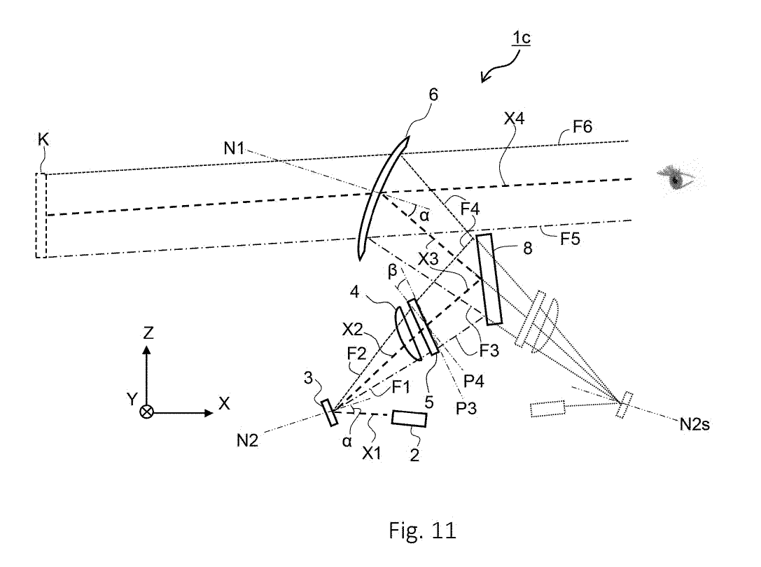

FIG. 11 illustrates an exemplary configuration of a display device 1c in Embodiment 4. The display device 1c illustrated in FIG. 11 has a configuration of the display device 1 illustrated in FIG. 1 further including a mirror 8 arranged between the screen 5 and the combiner 6. The arrangement of the screen 5, the mirror 3, and the light source 2 in the display device 1c illustrated in FIG. 11 is symmetrical to the arrangement of the screen 5, the mirror 3, and the light source 2 in the display device 1 illustrated in FIG. 1, with respect to the surface of the mirror 8. The optical system of the display device 1c can be considered substantially identical to the optical system of the display device 1. In other words, the optical positional relationship of the combiner 6, the screen 5, and the mirror 3 in the display device 1c can be made substantially identical to that in the display device 1.

For example, the normal line N1 of the incidence surface of the combiner 6, at a position at which the main light beam X3 is incident, is positioned on a side of the light beam F4 at the one-side end of the intermediate image, with respect to the main light beam X3, which is incident on the combiner 6. The normal line N2 of the reflection surface of the mirror 3 when displaying the center of the intermediate image, at a position at which the main light beam X2 is reflected, is positioned on the side of the light beam F1 at the other-side end of the intermediate image with respect to the main light beam X2 traveling from the mirror 3 toward the screen 5.

Further, the light outgoing surface P3 of the screen 5 is tilted, with respect to a plane P4 that is vertical to the outgoing direction of the main light beam X3 traveling from the screen 5 toward the combiner 6. The light outgoing surface P3 of the screen 5 is tilted in such a direction that the optical path of the light beam F4 at the one-side end of the intermediate image, from the screen 5 to the combiner 6, is shortened. In other words, the light outgoing surface P3 is tilted in such a manner that, in the plane containing the main light beam X3 and the normal line N1, the optical path of the light beam F4 at the one-side end of the intermediate image, between the screen 5 and the combiner 6, is shortened, whereas the optical path of the light beam F3 at the other-side end of the intermediate image, between the screen 5 and the combiner 6, is elongated.

The relative positional relationship among the mirror 3, the screen 5, and the lens 6b is set as illustrated in FIG. 11, whereby the distortion of the displayed image can be suppressed easily, as is the case with Embodiment 1. Besides, details of the exemplary arrangement of the same can be made identical to that in Embodiment 1.

For example, in the configuration illustrated in FIG. 11 as well, the combiner 6 and the mirror 3 can be arranged in such a manner that an incidence angle α of the main light beam X3 with respect to the combiner 6, and an incidence angle α of the beam X1 from the light source 2 with respect to the mirror 3 when displaying the center of the intermediate image, are approximately equal to each other. This makes it possible to cause the distortion of the image caused by the mirror 3, and the distortion of the image caused by the combiner 6, to be canceled efficiently with each other.

Further, in FIG. 11, the incidence angle of the main light beam X3 from the screen 5 to the combiner 6 is given as α. In this case, an angle β between the light outgoing surface P3 of the screen 5 and the plane P4 that is vertical to the main light beam X3 traveling from the screen 5 toward the combiner 6 can be set to, for example, 0.8α to 1.6α, and further preferably, α to 1.50α, as is the case with Embodiment 1. This makes it possible to efficiently suppress the distortion of the image, and further, to enhance the display quality.

In FIG. 11, the normal line N1 of the incidence surface of the combiner 6 (optical element), at a position at which the main light beam X3 is incident, and the normal line N2 of the reflection surface of the mirror 3 when displaying the center of the intermediate image, are not parallel with each other. The normal line N2s of the optical system symmetrical to the arrangement of the screen 5, the field lens 4, the mirror 3, and the light source 2, with respect to the surface of the mirror 8, that is, the substantially identical optical system, is parallel with the normal line N1. In such a case, the normal lines N1 and N2 can be considered optically parallel to each other. In this way, the embodiment in which the normal lines N1 and N2 are parallel encompasses a case where these are considered optically parallel in an optical system having the mirror 8. Likewise, the embodiment in which the contact plane P2 with respect to the combiner 6 (optical element) at a position at which the main light beam X3 is incident, and the reflection surface of the mirror 3 when displaying the center of the intermediate image, are approximately parallel to each other, encompasses a case where they are considered optically parallel to each other, as illustrated in FIG. 11.

It should be noted that the present embodiment can be applied, not only to Embodiment 1 described above, but also to Embodiment 2 or 3. Further, the position of the mirror 8 is not limited to the position between the screen 5 and the combiner 6. The mirror 8 may be arranged, for example, between the mirror 3 and the screen 5.

### Embodiment 5

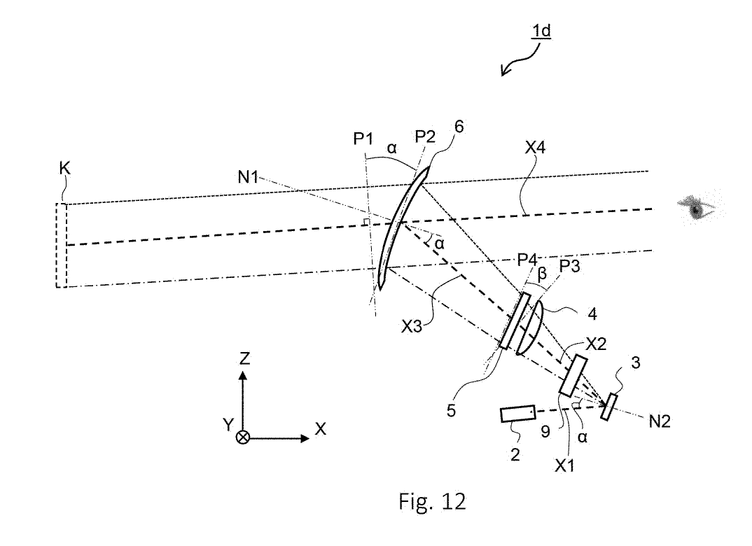

FIG. 12 illustrates an exemplary configuration of a display device 1d in Embodiment 5. The display device 1d has the configuration of the display device 1 illustrated in FIG. 1 further including an optical compensation element 9 for performing optical compensation. The optical compensation element 9 is provided between the mirror 3 and the screen 5. As the optical compensation element 9, for example, a compensation lens can be used. With the compensation lens, the beam diameter can be adjusted, and the distortion can be adjusted. By providing such an optical compensation element, higher-grade display can be realized.

The optical compensation element, alternatively, can be provided between the screen 5 and the combiner 6. Further, the optical compensation element is applicable, not only in the display device 1 in Embodiment 1, but also in the display devices 1a to 1c in Embodiments 2 to 4. For example, in the display device 1c in FIG. 11, the reflection surface of the mirror 8 can be formed in a shape for performing the optical compensation. By forming the reflection surface of the mirror 8 in, for example, a concave shape, the mirror 8 can be caused to have such an optical compensation function as the beam diameter adjustment, the distortion adjustment, or the like. In this case, the mirror 8 serves as the optical compensation element.

The embodiments of the present invention are described above, but the present invention is not limited to the above-described embodiments. For example, in the above-described embodiments, the main light beams X1 to X4 are contained in one plane, but the display device can be formed by using such an optical system that the main light beams X1 to X4 are not contained in one plane.

Further, the shape of the intermediate image can be controlled by, for example, the driving control of the light source 2 and the mirror 3, so as to correct the distortion. In other words, the distortion correction by the configuration of the optical system as is the case with the above-described embodiments, and the distortion correction by the image control, can be combined. In the case of the distortion correction by the image control, display quality deterioration such as resolution deterioration or the like occurs in some cases, but the distortion correction by the image control may be combined with the distortion correction by the configuration of the above-described optical system, which makes it easier to suppress the distortion, while suppressing the deterioration of the display quality.

Still further, the display device may have a configuration that does not include a combiner. As an example, in a case where the display device is applied to a head-up display of a vehicle such as an airplane or an automobile, the configuration may be such that a combiner is not provided, and light outgoing from the screen 5 is reflected by the windshield of the vehicle, so that a virtual image is obtained. Alternatively, a combiner may be bonded on the windshield, or embedded in the windshield.

In the above-described embodiments, an intermediate image is formed on he screen 5 with the light from the light source 2 and the mirror 3, and light passing through the screen 5 is reflected by the combiner 6, 7, whereby a display image is displayed as a virtual image. In contrast, the configuration may be such that light passing through the screen 5 is displayed as a real image.

### DESCRIPTION OF REFERENCE NUMERALS

1, 1a to 1d: display device
2: light source
3: mirror
4: field lens
5: screen
5: combiner (exemplary optical element)
6a: concave mirror (exemplary optical element)
6b: lens (exemplary optical element)
7: combiner
8: mirror
9: optical compensation element

1. A display device comprising:
a light source;
a mirror that reflects light from the light source;
a screen on which an intermediate image is formed with the light reflected by the mirror; and
an optical element that reflects light of the intermediate image on the screen, or allows the light of the intermediate image to pass therethrough, thereby generating a display image,
wherein a normal line of an incidence surface of the optical element on which a main light beam from the screen to the optical element is incident is positioned on a side of a light beam at a one-side end of the intermediate image, with respect to the main light beam incident on the optical element,
a normal line of a reflection surface of the mirror when displaying a center of the intermediate image is positioned on a side of a light beam at the other-side end of the intermediate image, with respect to a main light beam traveling from the mirror toward the screen, and
a light outgoing surface of the screen is tilted, with respect to a plane vertical to the main light beam traveling from the screen to the optical element, in such a direction that an optical path of the light beam at the one-side end of the intermediate image, between the screen and the optical element, is shortened.

2. The display device according to claim 1,
wherein an incidence angle of the main light beam with respect to the optical element, and an incidence angle of the light from the light source with respect to the mirror when displaying the center of the intermediate image, are approximately equal to each other.

3. The display device according to claim 1,
wherein, when the incidence angle of the main light beam from the screen to the optical element is given as α, an angle between the light outgoing surface of the screen and the plane vertical to the main light beam traveling from the screen toward the optical element is set to α to 1.5 α.

4. The display device according to claim 1,
wherein the normal line of the incidence surface of the optical element on which the main light beam is incident, and the normal line of the reflection surface of the mirror when displaying the center of the intermediate image, are approximately parallel.

5. The display device according to claim 1,
wherein the optical element has a reflection surface that reflects the light of the intermediate image from the screen thereby causing light of the display image to outgo, and
an angle between a direction of the main light beam incident on the optical element from the screen, and a direction of the main light beam outgoing from the optical element, thereby forming the display image, is approximately equal to an angle between a direction of light from the light source incident on the mirror when displaying the center of the intermediate image, and a direction of an outgoing light beam that outgoes from the mirror when displaying the center of the intermediate image and travels toward the screen.

6. The display device according to claim 1,
wherein the optical element allows light from a surface on a side opposite to the screen to pass therethrough, thereby superimposing background on the display image.

7. The display device according to claim 1, further comprising:
an optical member that reflects light from the optical element, thereby changing the direction of light of the display image, and at the same time, allows light from a surface on a side opposite to the optical element to pass therethrough, thereby superimposing background on the display image.

8. The display device according to claim 1, further comprising:
an optical compensation element provided, either between the mirror and the screen, or between the screen and the optical element, the optical compensation element performing optical compensation.
